(19) United States
(12) Patent Application Publication
(10) Pub. No.: US 2008/0005911 A1
(43) Pub. Date: Jan. 10, 2008

(54) Structure of knife

(75) Inventor: Bor-Haw Chang, Taipei (TW)

Correspondence Address: Asia Vital Components Co., Ltd., P.O.BOX 1-195, YUNG HO, TAIPEI HSIEN, omitted

(73) Assignee: ASIA VITAL COMPONENTS CO., LTD., HSIN-CHUANG (TW)

(21) Appl. No.: 11/481,380

(22) Filed: Jul. 6, 2006

(51) Int. Cl. B26B 9/00

(52) U.S. Cl. 30/346

(57) ABSTRACT

The present invention provides a structure of a knife. The knife has a carrier and at least one cutting groove positioned at the distal end of the carrier. The cutting groove has a first cutting portion and a second cutting portion. The first and the second cutting portions are arranged in a diamond shape.

### BACKGROUND OF THE INVENTION

1. Field of the Invention

The present invention generally relates to a knife, and more particularly to a structure of a knife including a cutting element and a carrier to secure the cutting element. More specifically, the present invention relates to a structure of a knife having a cutting groove.

2. Description of Related Art

A conventional structure of a knife comprises a main portion 10, wherein the main portion 10 comprises a positioning portion 20 to receive a protrusion 24. The positioning portion 20 is inwardly indented and the protrusion 24 for cutting is embedded in the positioning portion 20.

The protrusion 24 of the conventional knife may get damaged while cutting due to the rebound force.

Another structure of a conventional knife comprises a mechanical portion 14 formed at a distal end of a cutting tool 11. The mechanical portion 14 parallel to a hole 21 comprises a cutting edge 14b, and another cutting edge 14c is formed around the hole 21. The corresponding and simultaneous movement of the two cutting edges 14b and 14c in the hole 21 accordingly form a fluid pressure groove 21.

The groove 21 formed in conventional knife has a cutting route 21A from the top to the bottom, and the cutting surface is usually blunt, not sharp, and the bluntness interferes the fluid from flowing smoothly in the fluid pressure groove 21.

Therefore, how to overcome the conventional defect is an important issue for the manufacturers in the field.

### SUMMARY OF THE INVENTION

Accordingly, in the view of the foregoing, the present provides a structure of a knife.

According to an aspect of the present invention, the knife structure comprises a carrier and a cutting element secured at a distal end of the carrier.

### BRIEF DESCRIPTION OF THE DRAWING

For a more complete understanding of the present invention, reference will now be made to the following detailed description of preferred embodiments taken in conjunction with the following accompanying drawings.

FIG. 1 is a perspective view of a structure of a knife according to an embodiment of the present invention.

FIG. 2 is a side view of a knife according to an embodiment of the present invention.

FIG. 3 is a top view of a knife according to an embodiment of the present invention.

FIG. 4 is view showing the cutting trace according to the embodiment of the present invention.

### DETAIL DESCRIPTION OF THE INVENTION

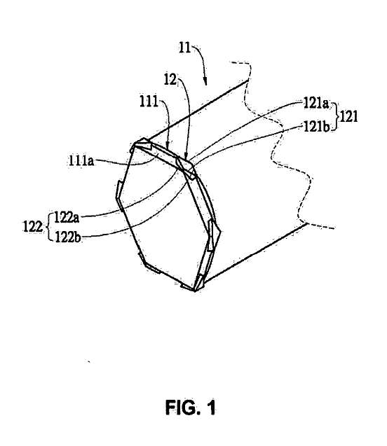

Referring to FIG. 1, the radiator comprises a carrier 11 and cutting grooves 12. The carrier 11 comprises at least one receiving portion 111a at a distal end 111 thereof to secure a plurality of cutting grooves 12. The carrier 11 and the cutting grooves 12 may be integrally formed. The cutting grooves 12 have a first cutting portion 121 and a second cutting portion 122 arranged in a diamond shape.

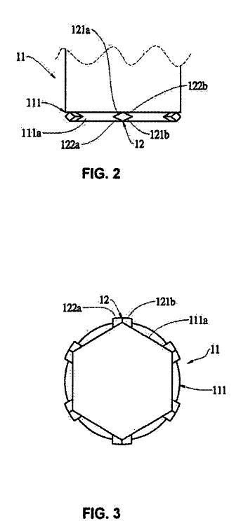

Referring to FIGS. 2 and 3, the first cutting portion 121 comprises a first cutting edge 121a and a second cutting edge 121b. The second cutting portion 122 comprises a first cutting edge 122a and a second cutting edge 122b.

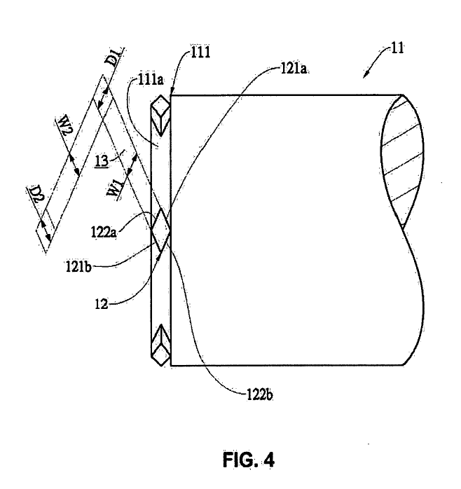

Referring to FIG. 4, while cutting, the width W1 of the groove 13 is equal to the length D1 of the first cutting portion 121, and the width W2 is equal to the length D2 of the second cutting portion 122.

Accordingly, the present invention has at least the following advantages.

1. The cutting groove 12 of the present invention is embedded and securely fixed to the receiving portion 111a of the distal end 111 of the carrier 11. Thus, a reinforced structure of the knife comprising the cutting groove 12 and the carrier 11 can be obtained.

2. While cutting, the width W1, W2 of the groove 13 is equal to the length D1, D2 of the first and second cutting portion 121, 122. Therefore, the width W1, W2 of the groove 13 depends on the length D1, D2 of the cutting groove 12.

While the invention has been described in conjunction with a specific best mode, it is to be understood that many alternatives, modifications, and variations will be apparent to those skilled in the art in light of the foregoing description. Accordingly, it is intended to embrace all such alternatives, modifications, and variations in which fall within the spirit and scope of the included claims. All matters set forth herein or shown in the accompanying drawings are to be interpreted in an illustrative and non-limiting sense.

What is claimed is:

1. A structure of a knife, comprising:
a carrier; and
a cutting groove, formed at a distal end of said carrier, wherein said cutting groove comprises a first cutting portion and a second cutting portion arranged in a diamond shape.

2. The structure of a knife according to claim 1, wherein said first cutting portion comprises a first cutting edge and a second cutting edge.

3. The structure of a knife according to claim 1, wherein said second cutting portion comprises a first cutting edge and a second cutting edge.

4. The structure of a knife according to claim 1, wherein said carrier is integrally formed with said cutting groove.

5. The structure of a knife according to claim 1, wherein said carrier comprises a receiving portion at a distal end thereof to secure said cutting groove.
